(19) United States
(12) Patent Application Publication
(10) Pub. No.: US 2018/0304128 A1
(43) Pub. Date: Oct. 25, 2018

(54) TURF REPAIR DISPENSER AND METHOD FOR TURF REPAIR

(71) Applicant: Bradford Allen, Walpole, MA (US)

(72) Inventor: Bradford Allen, Walpole, MA (US)

(21) Appl. No.: 15/779,333

(22) PCT Filed: Nov. 2, 2016
(86) PCT No.: PCT/US16/60058

§ 371 Date: May 25, 2018

Related U.S. Application Data
(60) Provisional application No. 62/270,287, filed on Dec. 21, 2015.

(51) Int. Cl. A63B 57/50

(52) U.S. Cl. CPC A63B 57/50; A01C 7/02

(57) ABSTRACT

One aspect of the invention provides a dispenser including a cylinder defining: a first, closed end; a second, open end; and an articulating region proximate to the second, open end. The articulating region is adapted and configured to: resiliently bend between at least: a first position in which all portions of the cylinder have a substantially linear profile; and a second position in which the articulating portion and any portion of the cylinder between the articulating portion and the second, open end of the cylinder bend at least 90° relative to a portion of the cylinder between the articulating region and first, closed end; and maintain either the first position or the second position without the need for force or support.

### CROSS-REFERENCE TO RELATED APPLICATION

This application claims priority to U.S. Provisional Patent Application Ser. No. 62/270,287, filed Dec. 21, 2015. The entire content of this application is hereby incorporated by reference herein.

### BACKGROUND OF THE INVENTION

A shot taken on a golf course can remove a portion of grass on the turf, leaving behind a patch on the turf in need of repair known as a “golf divot.”

### SUMMARY OF THE INVENTION

One aspect of the invention provides a dispenser including a cylinder defining: a first, closed end; a second, open end; and an articulating region proximate to the second, open end. The articulating region is adapted and configured to: resiliently bend between at least: a first position in which all portions of the cylinder have a substantially linear profile; and a second position in which the articulating portion and any portion of the cylinder between the articulating portion and the second, open end of the cylinder bend at least 90° relative to a portion of the cylinder between the articulating region and first, closed end; and maintain either the first position or the second position without the need for force or support.

This aspect of the invention can have a variety of embodiments. The articulating region can include a plurality of bellows. In the second position, the articulating portion and any portion of the cylinder between the articulating portion and the second, open end of the cylinder can bend at least 135° relative to the portion of the cylinder between the articulating region and first, closed end. In the second position, the articulating portion and any portion of the cylinder between the articulating portion and the second, open end of the cylinder can bend at least 180° relative to the portion of the cylinder between the articulating region and first, closed end. The articulating region can be adapted and configured to maintain a position selected from a plurality of substantially regular increments of about 15° to about 20° in between the first position and a bend of about 180° without the need for force or support.

The cylinder can be formed from plastic. The plastic can be polypropylene.

The cylinder can have an outer diameter between about ¾″ and about 1″. The cylinder can have an outer diameter of about 15/16″.

The dispenser can further include a turf repair composition received within the cylinder. The articulating region can be articulated to a position greater than a 90° bend to protect the turf repair composition from precipitation when positioned substantially vertically. The turf repair composition can include one or more of: grass seed, loam, and sand.

Another aspect of the invention provides a method of turf repair including: adjusting the articulating region of the dispensers described herein to a user-selected bend to modulate the dispensing speed of the turf repair composition; and rotating the dispenser to dispense at least a portion of the turf repair composition on an area of turf in need of repair.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 depicts a dispenser for turf repair in various positions according to embodiments of the invention.

FIG. 2 depicts a cross-section of a dispenser for turf repair according to embodiments of the invention.

FIG. 3 depicts a dispenser for turf repair in use according to embodiments of the invention.

FIG. 4 depicts a method of turf repair according to embodiments of the invention.

### DEFINITIONS

The instant invention is most clearly understood with reference to the following definitions:

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used in the specification and claims, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

### DETAILED DESCRIPTION OF THE INVENTION

### Golf Divot Repair

A well-struck shot on a golf course, particularly a shot taken on the fairway with an iron, can remove a portion of turfgrass, leaving behind a bald patch on the course or a “divot.” Repairing a divot is important in the maintenance of turf health. To this end, golf etiquette requires golfers to repair divots they create as they play.

However, it is not practical for golfers to carry a jug or bag of turf repair mixture in a golf bag, as golf bags are generally designed to carry clubs or similar long items. A bag or jug of seed mixture carried in a golf bag, for example, would be difficult to retrieve when needed as the golfer would need to rummage through compartments in the golf bag to find and retrieve the turf repair mixture. Also, the golfer would need to dispense an appropriate amount of the turf repair mixture into the divot, which can be challenging if the bag or jug is unwieldy to handle (e.g., a large amount of mixture easily spills out). Finally, after dispensing the mixture, the golfer would need to re-seal the bag or jug. If the bag or jug of mixture is not properly sealed, the turf repair mixture could spill in the golf bag as it is being carried around.

### Dispenser for Turf Repair

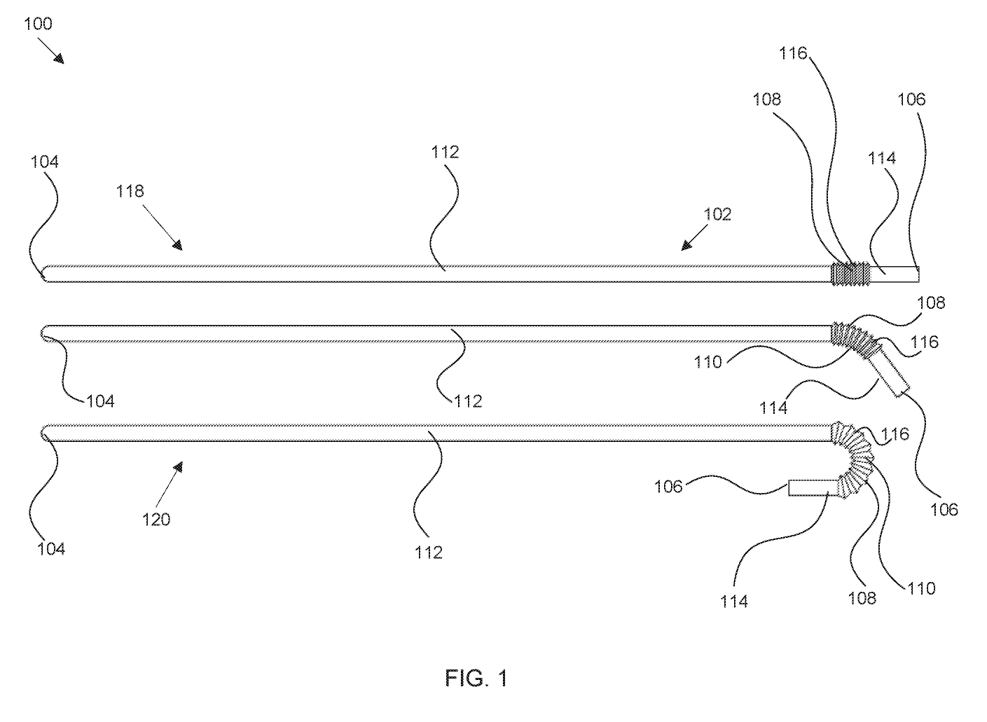

A container 100 for a turf repair composition 200 (e.g., a seed mixture, sand, loam, or combination thereof) having a shape or dimensions similar to a golf club (e.g., a thin, elongated tube) would better fit in a golf bag. Referring now to FIG. 1, in one aspect, the invention provides a dispenser 100 for turf repair. The dispenser includes a cylinder 102 that has a first, closed end 104 and a second, open end 106.

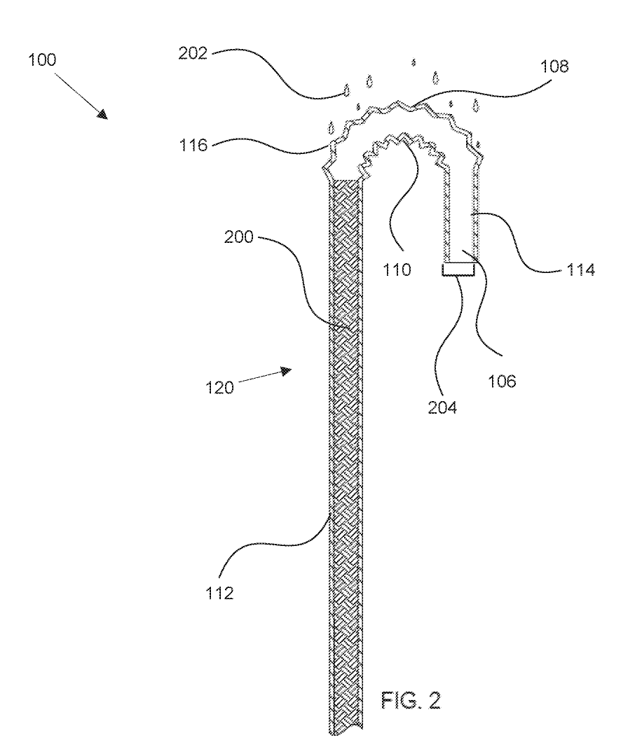

Referring now to FIG. 2, the dispenser 100 can hold turf repair composition 200 within the cylinder 102. The dispenser 100 can be filled with turf repair composition 200 via the second, open end 106. When carried in a golf bag during a round, for example, the dispenser can be placed substantially upright in the golf bag with the first, closed end 104 of the dispenser 100 at or near the bottom of the golf bag, and the second, open end 106 of the dispenser positioned at or near the top of the golf bag.

When positioned upright in a golf bag, the turf repair composition 200 in the dispenser 100 could be exposed to outside elements such as precipitation 202 through the second, open end 106. To protect the turf repair composition 200 from the elements, the dispenser 100 further includes an articulating region 108 adapted and configured to resiliently bend between a first position 118 and a second position 120. In some embodiments, the articulating region 108 is proximate to the second, open end 106.

As shown in FIG. 1, in the first position 118, all portions of the cylinder 102 have a substantially linear profile. In some embodiments, in the second position 120, the articulating portion 110 and any portion 114 of the cylinder between the articulating portion 110 and the second, open end 106 of the cylinder 102 bend at least 90°, at least 135°, or at least 180° relative to a portion 112 of the cylinder 102 between the articulating region 108 and first, closed end 104.

The articulating region 108 can be adapted and configured to maintain the first position 118 and/or the second position 120, without the need for force or support. The articulating region 108 can be adapted and configured to resiliently bend and maintain such positions, for example, by using an expansible or flexible structure, such as bellows 116 formed of a plastic material (e.g., polypropylene). In some embodiments, the articulating region 108 is adapted and configured to maintain any one of a set of positions between the first position 118 and a bend of about 180° in increments of about 15° to 20° each, without the need for force or support. For example, in some embodiments, the articulating region 108 is adapted and configured to maintain a position wherein the articulating portion 110 and any portion 114 of the cylinder between the articulating portion 110 and the second, open end 106 of the cylinder 102 bend at about 15°, about 20°, about 30°, about 40°, about 45°, about 60°, about 75°, about 80°, about 90°, about 100°, about 105°, about 120°, about 135°, about 140°, about 150°, about 160°, about 165°, or about 180° relative to a portion 112 of the cylinder 102 between the articulating region 108 and the first, closed end 104.

By being able to bend between and maintain these positions of the dispenser 100, a user is able to easily “open” and “close” the dispenser. For example, the user may “close” the dispenser by adjusting the articulating region 108 to a bend of about 180°. As shown in FIG. 2, for example, a bend of greater than 90° (e.g., a bend of about)180° protects the turf mixture 200 in the cylinder 102 from outside elements such as precipitation 202 when the dispenser 100 is positioned substantially vertically (for example, when the dispenser 100 is placed and carried around in a golf bag).

Preferably, as shown in FIG. 2, the dispenser 100 is filled with turf repair composition 200 from the first, closed end 104 to no higher than just below the portion of the articulating region 108 of the dispenser 100. By filling the dispenser 100 with composition 200 while leaving the articulating region 108 and portion 114 between the articulating portion 110 and second, open end 106 free of composition 200, the articulating region 108 can be more easily adjusted when “opening” or “closing” the dispenser 100. Also, spilling of composition 200 from the dispenser 100 while adjusting the articulating region 108 is avoided.

The articulating region 108 eliminates any need for elaborate opening, sealing, or covering of the dispenser 100 before or after use (e.g., screwing or unscrewing of a lid is not required). Once the dispenser 100 is bent to about a 180° bend, if the dispenser 100 is properly filled with turf repair composition 200 (e.g., filled to a level below the articulating region 108), the design of the dispenser 100 minimizes any risk of spilling turf repair composition 200 in the golf bag as the dispenser 100 is carried around.

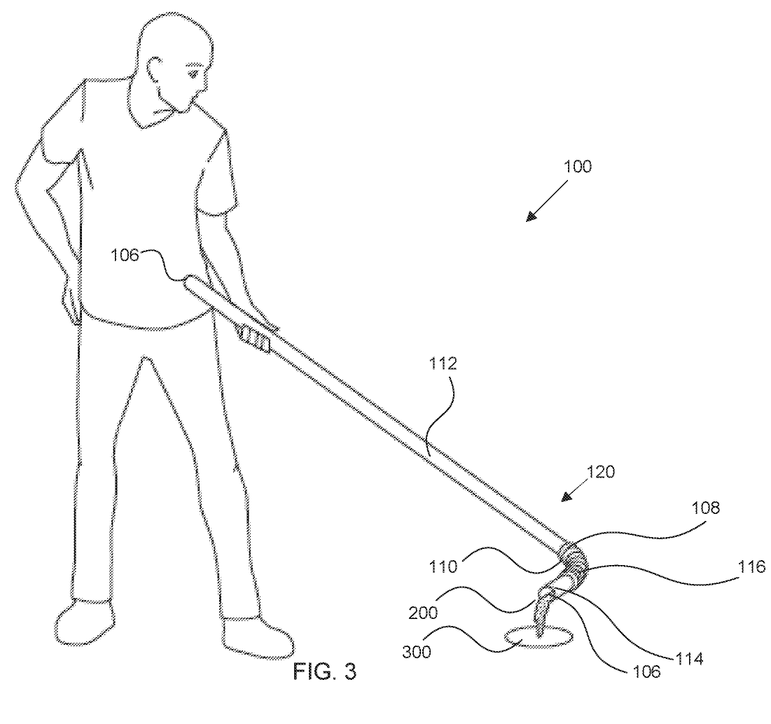

Further, by being able to bend and maintain the dispenser 100 in a variety of positions between 0° (i.e., the first position 118) and 180°, the user is able to selectively adjust and modulate the dispensing of turf repair composition 200 from the cylinder 102. As shown in FIG. 3, for example, the user can adjust the articulating region 108 to maintain the dispenser 100 at a bend between 0° and 90° and tilt the second, open end 106 near the divot 300 to dispense a desired amount of the turf repair composition 200 into the divot 300. The ability to selectively adjust and maintain the articulating region 108 at different positions (e.g., at a 30°, 45°, 60° or 90° bend) allows a user to better control the speed at which the turf repair composition 200 is being dispensed to the divot 300. This helps to avoid inadvertent spilling out of excess amounts of turf repair composition 200, thus minimizing waste of turf repair composition 200.

In particular embodiments, the size and/or dimensions of the dispenser 100 is similar to a golf club. In some embodiments, the dispenser 100, when filled with turf repair composition 200, has a size and weight similar to a 1-iron, 2-iron, 3-iron, 4-iron, 5-iron, 6-iron, 7-iron, 8-iron, or 9-iron (e.g., about 35″ to 40.5″ in length, and about 0.8 to 1 lbs. (or equivalently, about 360 to 454 grams) in weight). In one embodiment, the dispenser 100 has weight and dimensions similar to a 3-iron (e.g., about 39.5″ in length and about 0.9 lbs. (or equivalently, about 410 grams) in weight) when filled with turf repair composition 200 to just below the articulating region 108. The dispenser 100 can be formed of a plastic material, such as polypropylene. In some embodiments, all portions of the dispenser 100, including the articulating region 108 and bellows 116, are formed of polypropylene.

The cylinder 102 can have an outer diameter 204 between ¾″ and 1″. In a preferred embodiment, the cylinder has an outer diameter 204 of about 15/16″. Preferably, the size and/or dimensions of the dispenser 100 are selected such that the dispenser 100 is not too heavy for most users to carry when the dispenser 100 is filled with turf repair composition 200, and the dispenser 100 is not too prone to bending when filled with the composition 200.

The design of the dispenser 100 further permits easy filling or re-filling of the cylinder 102 with a turf repair composition 200. A golf course can order dispensers 100 empty, and subsequently supply a turf repair composition 200 that golf course staff or golfers can fill the dispenser 100 with. When empty, the dispensers 100 can be maintained in the first position 118 (i.e., the dispenser 100 having a substantially linear profile), allowing the dispensers 100 to be conveniently packaged, stored, or transported in conventional containers (e.g., boxes or barrels).

To fill the dispensers 100 with turf repair composition 200, a number of dispensers 100 can be tightly packed within a standard barrel or other container in the first position 118 and filled with a turf repair composition 200 by golf course staff by pouring the composition 200 over the packed dispensers 100. The barrel of dispensers 100 could then be shaken or vibrated to allow the composition 200 poured over the dispensers 100 to settle within the cylinder 102. Excess composition 200 could be recovered from within and/or around the barrel.

Thus, a golf course can easily change or customize the turf repair composition(s) 200 to be used at its facilities. A user can also easily carry multiple dispensers 100 in a golf bag if additional amounts of composition 200 is expected to be required. Alternatively, users can carry dispensers 100 that can each contain a different turf repair composition 200 for more particular or customized repair of a divot 300 (e.g., repair of one type of turf vs. another type of turf). The filled dispensers 100 can also be placed at a variety of locations around the golf course (e.g., at tee boxes, pro shop), making it convenient for golfers to obtain additional filled dispensers 100 as needed during their game. Further, the golf course can also designate various locations on the course where golfers can drop off used, empty dispensers 100 that can be re-used or re-filled with turf repair composition 200 by course staff.

The turf repair composition 200 can include grass seed, sand, loam, or any combination thereof. In some embodiments, the turf repair composition 200 includes one or more types of grass seed for re-seeding the divot 300. The grass seed can be any turfgrass seed, such as Bermudagrass, Kentucky bluegrass, perennial ryegrass, Zoysiagrass, or bentgrass seed. In other embodiments, the turf repair composition includes sand to protect the root structure of the damaged turf 300.

### Method of Turf Repair

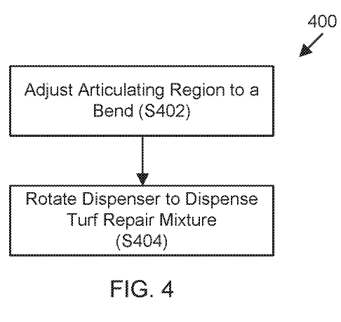

Referring now to FIG. 4, in another aspect, the invention provides a method 400 of turf repair. In one embodiment, the method 400 includes the step S402 of adjusting the articulating region 108 of the dispenser 100 to a bend selected by the user to modulate the dispensing speed of the turf repair composition 200. For example, the articulating region 108 can be adjusted to a bend less than or about equal to 90° (e.g., a 15°, 20°, 30°, 40°, 45°, 60°, 75°, 80° or 90° bend). A bend of a smaller angle (e.g., a bend between 15° and 30°) can allow turf repair composition to be dispensed more rapidly. Conversely, a bend of a greater angle (e.g., a bend between 75° and 90°) can allow turf repair composition to be dispensed more slowly. Because the articulating region 108 of the dispenser 100 has a flexible and expansible structure (e.g., bellows 116), the articulating region is easily adjusted to a selected bend by simply moving appropriate portion(s) of the dispenser to achieve the desired bend. For example, the portion 114 between the articulating portion 110 and second, open end 106, can be moved relative to the portion 112 between the articulating portion 110 and first, closed end 104 to form the desired bend.

The method 400 further includes the step S404 of rotating the dispenser 100 to dispense at least a portion of the turf repair composition 200 on an area of turf in need of repair 300. In some embodiments, the dispenser 100 has a size and/or dimensions similar to a golf club (e.g., a 3-iron). Thus, the dispenser 100 can be held and rotated by the user in a similar manner that the user would hold a golf club or rotate the head of a golf club.

In some embodiments, e.g., as shown for example in FIG. 3, the dispenser 100 is held with a single hand at a portion of the cylinder 102 proximate to the first, closed end 104 when the dispenser 100 is rotated. In some other embodiments, the dispenser is rotated from a position where the second, open end 106 is facing upward or away from the ground such that turf repair composition 200 is not spilled out, to a position where the second, open end 106 is facing downward or toward the ground such that turf repair composition 200 is dispensed from the dispenser 100.

In addition to adjusting the angle of the bend of the dispenser 100, the user can also adjust the degree of rotation to modulate the speed of dispensing the turf repair composition 200. In particular, the user can adjust the degree to which the second, open end 106 faces the ground. For example, by rotating the dispenser so that the second, open end 106 directly faces toward the ground, the user can increase the speed of dispensing. Conversely, the user can slow the speed of dispensing or terminate the dispensing of turf repair composition 200 by rotating the dispenser such that second, open end 106 faces a direction away or opposite from the ground.

### Equivalents

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

1. A dispenser comprising:
a cylinder defining:
a first, closed end;
a second, open end; and
an articulating region proximate to the second, open end, the articulating region adapted and configured to:
resiliently bend between at least:
a first position in which all portions of the cylinder have a substantially linear profile; and
a second position in which the articulating portion and any portion of the cylinder between the articulating portion and the second, open end of the cylinder bend at least 90° relative to a portion of the cylinder between the articulating region and first, closed end; and
maintain either the first position or the second position without the need for force or support; and
a turf repair composition received within the cylinder.

2. The dispenser of claim 1, wherein the articulating region includes a plurality of bellows.

3. The dispenser of claim 1, wherein in the second position, the articulating portion and any portion of the cylinder between the articulating portion and the second, open end of the cylinder bend at least 135° relative to the portion of the cylinder between the articulating region and first, closed end.

4. The dispenser of claim 1, wherein in the second position, the articulating portion and any portion of the cylinder between the articulating portion and the second, open end of the cylinder bend at least 180° relative to the portion of the cylinder between the articulating region and first, closed end.

5. The dispenser of claim 1, wherein the articulating region is adapted and configured to maintain a position selected from a plurality of substantially regular increments of about 15° to about 20° in between the first position and a bend of about 180° without the need for force or support.

6. The dispenser of claim 1, wherein the cylinder is formed from plastic.

7. The dispenser of claim 6, wherein the plastic is polypropylene.

8. The dispenser of claim 1, wherein the cylinder has an outer diameter between about ¾″ and about 1″.

9. The dispenser of claim 1, wherein the cylinder has an outer diameter of about 15/16″.

10. (canceled)

11. The dispenser of claim 1, wherein the articulating region is articulated to a position greater than a 90° bend to protect the turf repair composition from precipitation when positioned substantially vertically.

12. The dispenser of claim 1, wherein the turf repair composition comprises one or more of: grass seed, loam, and sand.

13. A method of turf repair comprising:
adjusting the articulating region of the dispenser of claim 1 to a user-selected bend to modulate the dispensing speed of the turf repair composition; and
rotating the dispenser to dispense at least a portion of the turf repair composition on an area of turf in need of repair.
